(19) United States
(12) Patent Application Publication
(10) Pub. No.: US 2021/0205888 A1
(43) Pub. Date: Jul. 8, 2021

(54) FEEDSTOCK FOR 3D PRINTING, PREPARATION METHOD AND APPLICATION THEREOF

(71) Applicant: Kunshan Kadam New Material Technology Co., Ltd., Kunshan City, Jiangsu Province (CN)

(72) Inventors: Chunshu HOU, Jiangsu (TW); Longjin ZHOU, Kunshan City, Jiangsu Province (CN); Wenjie HOU, Kunshan City, Jiangsu Province (CN)

(73) Assignee: Kunshan Kadam New Material Technology Co., Ltd., Kunshan City, Jiangsu Province (CN)

(21) Appl. No.: 16/069,475

(22) PCT Filed: Mar. 7, 2018
(86) PCT No.: PCT/CN2018/078306

§ 371 Date: Jul. 11, 2018

(30) Foreign Application Priority Data
May 23, 2017 (CN) 201710367897.5

(51) Int. Cl. B22F 10/18; B22F 1/02; B33Y 10/00; B33Y 70/10

(52) U.S. Cl. CPC B22F 10/18; B22F 1/02; B22F 2301/205; B33Y 70/10; B33Y 10/00

(57) ABSTRACT

The present invention relates to a feedstock for 3D printing, a preparation method and an application thereof. The feedstock is polymer binder-coated metal powder, being in a linear shape. After being printed into a green body with a preset shape via a 3D printer, the linear feedstock is sequentially degreased and sintered, so that a metal product with a complex structure and high accuracy can be obtained. Compared with the prior art, the linear feedstock is applied to 3D printing, so that waste of raw materials can be avoided; the accuracy of a product surface is controlled and the quality of products is improved by selecting different wire diameters of the feedstock and controlling the heating temperature; and melting treatment can be performed by a simple thermocouple without need for complex and dear laser heating equipment, so that production cost is reduced. The powder injection molding technology and 3D printing technology are combined, so that complex products can be quickly printed and manufactured, development flow is shortened, and mass production popularization is realized. The feedstock has good economic benefits and wide application prospect.

### TECHNICAL FIELD

The present invention relates to the field of preparation of metal materials, specifically to a feedstock for 3D printing, a preparation method and an application thereof.

### BACKGROUND

3D printing technology, which is also known as three-dimension printing technology, is a technology to build objects in a manner of layer-by-layer printing by using adhesive materials such as powdery metals or plastics on the basis of digital model files. It can generate parts with any shape directly from computer graphic data without mechanical processing or any mold, thereby greatly shortening the product development cycles, increasing productivity and reducing production costs. Products such as lampshades, body organs, jewelry, tailored football shoes based on player's foot types, racing parts, solid-state batteries, and personalized mobile phones, violins, etc. can be manufactured by using this technology.

The 3D printing technology is actually a general designation of a series of rapid prototyping modeling technologies, all of which have a basic principle of laminated manufacturing, in which the cross-section shape of a workpiece is formed by scanning in the X-Y plane and the displacement of the layer thickness is performed intermittently on the Z coordinate by a rapid prototyping machine to eventually create a three-dimensional article. At present, rapid prototyping technologies on the market are divided into 3DP technology, SLA (with a full name of “Stereo lithography Appearance”), SLS (with a full name of “Selective Laser Sintering”), DMLS (with a full name of “Direct Metal Laser-Sintering”) and 1-DM (with a full name of “Fused Deposition Modeling”), etc.

The 3D printing technology was first applied to plastic materials. FDM technology, which is currently the main manner, is to heat to melt hot-melt materials, while the materials are selectively coated on the platform by a three-dimensional nozzle under the control of a computer according to the outline information of the cross-section, and after rapid cooling a layer of cross-section is formed. Once a layer is formed, the platform of the machine is lowered by a certain height (i.e., thickness for separating layers) to continue modeling until the modeling of the entire object is completed. The FDM technology has various types of molding materials and the molded parts have high accuracy and low price. The FDM technology is mainly suitable for molding small plastic parts. However, the plastic products produced in this way have low strength and cannot meet customers' requirements. In order to increase the strength of products and to improve the performance of products, DMLS technology employs alloy materials as raw materials, and utilizes metal laser sintering to melt the raw materials for 3D printing. The DMLS technology has characteristics of high accuracy, high strength, high speed, smooth surface of finished products, etc., and is generally used in aerospace and industrial accessories manufacturing industries, and can be used for designing high-level molds. However, due to the complexity of laser sintering equipment and the high energy consumption in the preparation process, synthetically considering factors such as product resolution, equipment costs, product appearance requirements and mass production capacity, FDM cannot be widely applied at present.

Powder injection molding (PIM) technology has characteristics of high accuracy, uniform organization, excellent performances and low production costs, and has been rapidly developed in recent years. In the sintering process, the product is shrunk by 10-30%, such that the surface roughness and accuracy of the final product is much better than those of DMLS technology. Therefore, if the powder injection molding technology can be combined with 3D printing, the advantages of the two technologies can be effectively integrated, the quality of the products can be improved, the production costs can be reduced, while a widely application of the products can be achieved.

CN106270510A discloses a method for printing and manufacturing metal/alloy parts by using a plastic 3D printer. The method includes steps of raw material sintering pretreatment, raw material coating, powder reduction, 3D printing, degreasing, sintering, etc. CN106426916A discloses a 3D printing method comprising: mixing a powdery material to be processed and a powdery nylon material; using selective laser sintering technology to melt the nylon material to bond the material to be processed to form a green body; heating the green body for thermal degreasing to volatilize the nylon material; heating the green body to the sintering temperature of the material to be processed to sinter the green body; reducing the ambient temperature of the green body to room temperature to obtain a dense part. Although the powder injection molding technology is combined with 3D printing technology in both of the above two methods, both of the feedstock are in powdery or granular mode, having the following disadvantages: when using powdery or granular raw materials for 3D printing, the raw materials need to be spread and coated throughout the entire area from the bottom up layer by layer, which greatly increases the amount of feedstock and causes material waste. In the melting process, melt cross-linking is easy to occur between materials due to the too large hot zone; when using laser to heat to melt to bond, due to the low melting point of the polymer material, the surrounding material is easily heated to melt, thereby affecting the accuracy and appearance of the product. In addition, as the irregular form of powdery or granular feedstock, it is impossible to carry out an effective and uniform coating, which can easily cause uneven surface thickness of the product.

### SUMMARY OF THE INVENTION

The following is a summary of the subject matter described herein in detail. This summary is not intended to limit the protection scope of the claims.

In view of the deficiencies in the prior art, an embodiment of the present invention provides a feedstock for 3D printing, wherein the feedstock is in a linear shape, thereby avoiding problems such as waste of raw materials, complicated and expensive equipment, insufficient accuracy and the like resulting from the shape of the feedstock when combining existing powder injection molding technology with 3D printing technology.

In order to achieve the goal, the following technical solutions are adopted by the embodiments of the present invention:

In a first aspect, an embodiment of the present invention provides a feedstock for 3D printing, the feedstock is polymer binder-coated metal powder, being in a linear shape.

In an embodiment of the present invention, the powder injection molding technology is combined with 3D printing technology to obtain a linear feedstock for 3D printing. When the feedstock is applied to 3D printing, materials can be fed according to the amount of materials required for each layer of the print part, saving raw materials; in addition, the accuracy of the product surface can be controlled by selecting different feedstock wire diameters and controlling the heating temperature; and the feedstock prepared by an embodiment of the present invention can be melted by heating with ordinary thermocouples without need for expensive laser equipment.

According to an embodiment of the present invention, the feedstock consists of the following components by volume percentage: 15-75% of metal powder; 25-85% of polymer binder.

The content of metal powder in the feedstock is 15-75% by volume percentage, for example, may be 15%, 20%, 25%, 30%, 35%, 40%, 45%, 50%, 55%, 60%, 65%, 70% or 75%, as well as specific values between the above values, which are no longer listed exhaustively herein due to the limitation of space and for concise considerations.

The content of polymer binder in the feedstock is 25-85% by volume percentage, for example, may be 25%, 30%, 35%, 40%, 45%, 50%, 55%, 60%, 65%, 70%, 75%, 80% or 85%, as well as specific values between the above values, which are no longer listed exhaustively herein due to the limitation of space and for concise considerations.

The sum of the metal powder and the polymer binder is 100% by volume percentage.

According to an embodiment of the present invention, the linear feedstock has a diameter of 0.1-5 mm, for example, may be 0.1 mm, 0.5 mm, 1 mm, 1.5 mm, 2 mm, 2.5 mm, 3 mm, 3.5 mm, 4 mm, 4.5 mm or 5 mm, as well as specific values between the above values, which are no longer listed exhaustively herein due to the limitation of space and for concise considerations.

In an embodiment of the present invention, preferably, the linear feedstock has a diameter of 1-3 mm.

According to an embodiment of the present invention, the metal powder is any one of titanium and/or titanium alloy powder, copper and/or copper alloy powder, aluminum and/or aluminum alloy powder, iron and/or iron alloy powder, neodymium and/or neodymium alloy powder, and preferably is titanium and/or titanium alloy powder.

According to an embodiment of the present invention, the polymer binder is plastic-based binder or wax-based binder. Both the plastic-based binder and the wax-based binder are commonly used in metal injection molding process, and specific components thereof are not specifically limited herein; preferably, the main filler of the plastic-based binder is polyoxymethylene (POM) and the main filler of the wax-based binder is paraffin wax (PW).

In a second aspect, an embodiment of the present invention provides a method for preparing the feedstock for 3D printing according to the first aspect, the method comprising the following steps:

(1) mixing formula amounts of metal powder and polymer binder, such that the polymer binder is coated on the surface of the metal powder;

(2) extruding and molding the polymer binder-coated metal powder obtained in step (1) into a linear shape, and cooling to obtain the feedstock for 3D printing.

According to an embodiment of the present invention, the mixing in step (1) is performed at a temperature of 165-200° C., for example, may be 165° C., 170° C., 175° C., 180° C., 185° C., 190° C., 195° C., or 200° C., as well as specific values between the above values, which are no longer listed exhaustively herein due to the limitation of space and for concise considerations.

The mixing in step (1) of an embodiment of the present invention is preferably performed at a temperature of 175-190° C., further preferably at 185° C.

According to an embodiment of the present invention, the mixing in step (1) is performed for 0.5-2 h, for example, may be 0.5 h, 0.8 h, 1 h, 1.2 h, 1.5 h, 1.8 h, or 2 h, as well as specific values between the above values, which are no longer listed exhaustively herein due to the limitation of space and for concise considerations.

The mixing in step (1) of an embodiment of the present invention is preferably performed for 1 h.

In an embodiment of the present invention, the manufactured linear feedstock is wound into a disk shape, which is favorable for continuous operation and production.

In a third aspect, an embodiment of the present invention provides an application of the feedstock according to the first aspect, the feedstock being applied in 3D printing.

Preferably, the application includes the following steps:

(1) using the linear feedstock as a raw material to print a green body with a preset shape via a 3D printer;

(2) degreasing the green body obtained in step (1) to obtain a brown body;

(3) sintering the brown body obtained in step (3) to obtain a sintered part;

(4) optionally, post-processing the sintered part obtained in step (3).

According to an embodiment of the present invention, based on the total amount, the amount of polymer binder which is removed from the brown body in step (2) is 8-12%, for example, may be 8%, 8.5%, 9%, 9.5%, 10%, 10.5%, 11%, 11.5% or 12%, as well as specific values between the above values, which are no longer listed exhaustively herein due to the limitation of space and for concise considerations.

According to an embodiment of the present invention, the method of degreasing in step (2) is any one of thermal degreasing, water degreasing, acid degreasing, and organic solvent degreasing.

According to an embodiment of the present invention, the medium for acid degreasing is nitric acid or oxalic acid.

According to an embodiment of the present invention, the sintering in step (3) is performed at a temperature of 1200-1450° C., for example, may be 1200° C., 1210° C., 1220° C., 1230° C., 1240° C., 1250° C., 1260° C., 1270° C., 1280° C., 1290° C., 1300° C., 1360° C., 1400° C. or 1450° C., as well as specific values between the above values, which are no longer listed exhaustively herein due to the limitation of space and for concise considerations.

The sintering in step (3) of an embodiment of the present invention is preferably performed at a temperature of 1240-1360° C.

According to an embodiment of the present invention, the sintering in step (3) is performed for 2-3 h, for example, may be 2 h, 2.1 h, 2.2 h, 2.3 h, 2.4 h, 2.5 h, 2.6 h, 2.7 h, 2.8 h, 2.9 h or 3 h, as well as specific values between the above values, which are no longer listed exhaustively herein due to the limitation of space and for concise considerations.

Compared with the prior art, embodiments of the present invention have at least the following beneficial effects:

(1) Waste of raw materials will be avoided. The accuracy of the product surface can be controlled by selecting different wire diameters of the feedstock and controlling the heating temperature, improving the quality of products.

(2) The melting process can be performed with simple thermocouples without need for complex and expensive laser heating equipment, reducing energy consumption and reducing production costs.

(3) The powder injection molding technology and 3D printing technology are combined to allow quickly printing complex products, shortening the development process and achieving mass production.

Other aspects can be understood after reading and understanding the drawings and detailed description.

### DESCRIPTION OF THE DRAWINGS

FIG. 1 is a process flow diagram of preparation and application of the feedstock provided by a specific embodiment of the present application.

The embodiments of the present invention will be further described in detail as following. However, the following embodiments are merely illustrative examples of the present application and do not represent or limit the protection scope of the present application. The protection scope of the present application is subject to the claims.

### DETAILED DESCRIPTION

The technical solutions of the present application will be further described below with reference to the accompanying drawings and by specific embodiments.

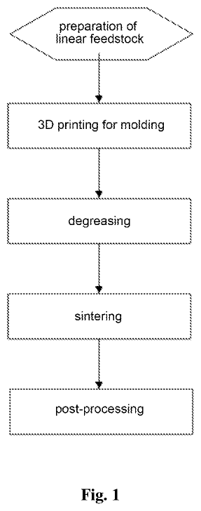

As shown in FIG. 1, the process for preparation and application of the feedstock provided by a specific embodiment of the present application can be: a metal powder and a polymer binder are mixed to prepare a linear feedstock, and the obtained feedstock is printed and molded by using 3D printing to obtain a green body, and the obtained green body is successively subjected to degreasing, sintering and post-processing to obtain a finished product.

In order to better illustrate the present application and facilitate understanding of the technical solutions of the present application, typical but non-limiting examples of the present application are as follows:

### Example 1

A preparation method of a feedstock for 3D printing is as follows:

(1) 60 vol % of titanium metal powder was mixed with 40 vol % of polymer binder, the polymer binder including: 85 wt % of polyoxymethylene, 14 wt % of polypropylene, and 1 wt % of stearic acid; the raw materials were added into an internal mixer and mixed at 170° C. for 1 h;

(2) The material obtained after mixing in the step (1) was extruded into a linear material with a diameter of 2 mm by using an extruder, cooled to obtain a feedstock for 3D printing, and the linear feedstock was wound into a disk shape for use.

The application of the feedstock for 3D printing obtained in this example includes the following steps:

(1) The linear feedstock was used as a raw material to print a green body with a preset shape via a 3D printer;

(2) The green body obtained in step (1) was degreased at 110° C. for 4 h using nitric acid as a medium, 10% of polymer binder was removed to obtain a brown body;

(3) The brown body obtained in step (2) was placed in a vacuum furnace, sintered at 1250° C. for 3 h, and cooled to obtain a titanium-based product.

### Example 2

A preparation method of a feedstock for 3D printing is as follows:

(1) 50 vol % of titanium alloy powder was mixed with 50 vol % of polymer binder, the polymer binder including: 80 wt % of paraffin wax, 19.5 wt % of polyethylene and 0.5 wt % of stearic acid; the raw materials were added into an internal mixer and mixed at 200° C. for 0.5 h;

(2) The material obtained after mixing in the step (1) was extruded into a linear material with a diameter of 3 mm by using an extruder, cooled to obtain a feedstock for 3D printing, and the linear feedstock was wound into a disk shape for use.

The application of the feedstock for 3D printing obtained in this example includes the following steps:

(1) The linear feedstock was used as a raw material to print a green body with a preset shape via a 3D printer;

(2) The green body obtained in step (1) was soaked at 80° C. for 6 h using heptane as a medium, 12% of polymer binder was removed to obtain a brown body;

(3) The brown body obtained in step (2) was placed in a vacuum furnace, sintered at 1260° C. for 2.5 h, and cooled to obtain a titanium alloy-based product.

(4) The titanium alloy-based product obtained in step (3) was post-processed according to customer requirements.

### Example 3

A preparation method of a feedstock for 3D printing is as follows:

(1) 70 vol % of copper powder was mixed with 30 vol % of polymer binder, the polymer binder including: 84 wt % of paraffin wax, 14 wt % of polypropylene and 2 wt % of stearic acid; the raw materials were added into an internal mixer and mixed at 165° C. for 2 h;

(2) The material obtained after mixing in the step (1) was extruded into a linear material with a diameter of 5 mm by using an extruder, cooled to obtain a feedstock for 3D printing, and the linear feedstock was wound into a disk shape for use.

The application of the feedstock for 3D printing obtained in this example includes the following steps:

(1) The linear feedstock was used as a raw material to print a green body with a preset shape via a 3D printer;

(2) The green body obtained in step (1) was soaked at 60° C. for 8 h using heptane as a medium, 11% of polymer binder was removed to obtain a brown body;

(3) The brown body obtained in step (2) was placed in a vacuum furnace, sintered at 1030° C. for 2 h, and cooled to obtain a copper-based product.

### Example 4

A preparation method of a feedstock for 3D printing is as follows:

(1) 50 vol % of titanium metal powder was mixed with 50 vol % of polymer binder, the polymer binder including: 70 wt % of polyoxymethylene, 27.5 wt % of polypropylene, and 2.5 wt % of stearic acid; the raw materials were added into an internal mixer and mixed at 185° C. for 1 h;

(2) The material obtained after mixing in the step (1) was extruded into a linear material with a diameter of 1.5 mm by using an extruder, cooled to obtain a feedstock for 3D printing, and the linear feedstock was wound into a disk shape for use.

The application of the feedstock for 3D printing obtained in this example includes the following steps:

(1) The linear feedstock was used as a raw material to print a green body with a preset shape via a 3D printer;

(2) The green body obtained in step (1) was soaked at 120° C. for 3 h using nitric acid as a medium, 8% of polymer binder was removed to obtain a brown body;

(3) The brown body obtained in step (2) was placed in a vacuum furnace, sintered at 1250° C. for 3 h, and cooled to obtain a titanium-based product.

### Example 5

A preparation method of a feedstock for 3D printing is as follows:

(1) 60 vol % of stainless steel powder was mixed with 40 vol % of polymer binder, the polymer binder including: 70 wt % of polyoxymethylene, 28 wt % of polypropylene, and 2.0 wt % of stearic acid; the raw materials were added into an internal mixer and mixed at 185° C. for 1 h;

(2) The material obtained after mixing in the step (1) was extruded into a linear material with a diameter of 1.75 mm by using an extruder, cooled to obtain a feedstock for 3D printing, and the linear feedstock was wound into a disk shape for use.

The application of the feedstock for 3D printing obtained in this example includes the following steps:

(1) The linear feedstock was used as a raw material to print a green body with a preset shape via a 3D printer;

(2) The green body obtained in step (1) was soaked at 120° C. for 3 h using nitric acid as a medium, 8% of polymer binder was removed to obtain a brown body;

(3) The brown body obtained in step (2) was placed in a vacuum furnace, sintered at 1360° C. for 3 h, and cooled to obtain a stainless steel-based product.

The preferred embodiments of the present application have been described in detail above. However, the present application is not limited to the specific details in the above embodiments. Various simple variations of the technical solutions of the present application may be made within the technical concept of the present application, and all these simple variations belong to the protection scope of the present application.

In addition, it should be noted that the specific technical features described in the above specific embodiments can be combined in any suitable manner without contradiction. In order to avoid unnecessary duplication, various possible combinations will not be further explained in the present application.

In addition, any combination may also be made between various different embodiments of the present application as long as it does not violate the idea of the present application, which should also be regarded as disclosure of the present application.

1. A feedstock for 3D printing, wherein the feedstock is polymer binder-coated metal powder, being in a linear shape.

2. The feedstock according to claim 1, wherein the feedstock consists of the following components by volume percentage: 15-75% of metal powder; 25-85% of polymer binder.

3. The feedstock according to claim 2, wherein the linear feedstock has a diameter of 0.1-5 mm.

4. The feedstock according to claim 3, wherein the linear feedstock has a diameter of 1-3 mm.

5. The feedstock according to claim 1, wherein the metal powder is any one of titanium and/or titanium alloy powder, copper and/or copper alloy powder, aluminum and/or aluminum alloy powder, iron and/or iron alloy powder, neodymium and/or neodymium alloy powder.

6. A preparation method of the feedstock for 3D printing according to claim 1, wherein the method comprises the following steps:
(1) mixing formula amounts of metal powder and polymer binder, such that the polymer binder is coated on the surface of the metal powder;
(2) extruding and molding the polymer binder-coated metal powder obtained in step (1) into a linear shape, and cooling to obtain the feedstock for 3D printing.

7. The method according to claim 6, wherein the mixing in step (1) is performed at a temperature of 165-200° C.

8. The method according to claim 6, wherein the linear feedstock obtained in step (2) is wound into a disk shape for use.

9. An application of the feedstock according to claim 1, wherein the feedstock is applied in 3D printing.

10. The application according to claim 9, wherein the application includes the following steps:
(1) using the linear feedstock as a raw material to print a green body with a preset shape via a 3D printer;
(2) degreasing the green body obtained in step (1) to obtain a brown body;
(3) sintering the brown body obtained in step (3) to obtain a sintered part;
(4) optionally, post-processing the sintered part obtained in step (3).

11. The application according to claim 10, wherein based on the total amount, the amount of polymer binder which is removed from the brown body is 8-12%.

12. The application according to claim 10, wherein the sintering in step (3) is performed at a temperature of 1200-1450° C.

13. The feedstock according to claim 1, wherein the metal powder is titanium and/or titanium alloy powder.

14. The feedstock according to claim 1, wherein the polymer binder is plastic-based binder or wax-based binder.

15. The method according to claim 6, wherein the mixing in step (1) is performed for 0.5-2 h.

16. The application according to claim 10, wherein the method of degreasing in step (2) is any one of thermal degreasing, water degreasing, acid degreasing, and organic solvent degreasing.

17. The application according to claim 16, wherein the medium for acid degreasing is nitric acid or oxalic acid.

18. The application according to claim 10, wherein the sintering in step (3) is performed for 2-3 h.
